(19) United States
(12) Patent Application Publication
(10) Pub. No.: US 2009/0218931 A1
(43) Pub. Date: Sep. 3, 2009

(54) MANUFACTURING METHOD OF ELECTROPHORESIS DISPLAY DEVICE, ELECTROPHORESIS DISPLAY DEVICE, AND ELECTRONIC APPARATUS

(75) Inventor: Yasuhiro Shimodaira, Fujimi-machi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/393,675

(22) Filed: Feb. 26, 2009

(30) Foreign Application Priority Data
Feb. 28, 2008 (JP) 2008-047570

(51) Int. Cl. H01J 1/62; H01J 9/20

(52) U.S. Cl. 313/498; 250/492.2; 257/E33.001; 257/E21.023

(57) ABSTRACT

A manufacturing method of an electrophoretic display device including a pair of substrates with an electrophoretic element therebetween, the electrophoretic element containing electrophoretic particles therein, and a display portion with a plurality of pixels arranged therein, each pixel including a selection transistor and a latch circuit connected to the selection transistor, the manufacturing method including a semiconductor portion forming process for forming a first semiconductor portion which constitutes the selection transistor and a second semiconductor portion composed of a plurality of transistors which constitutes a feedback inverter of the latch circuit so that the first semiconductor portion and the second semiconductor portion are placed in a straight line form extending in a direction of arrangement of the pixels, and an irradiating process for irradiating the first and second semiconductor portions with pulse-form light along the arrangement of the straight line form.

### BACKGROUND

1. Technical Field

The present invention relates to a manufacturing method of an electrophoretic display device, an electrophoretic display device, and an electronic apparatus.

2. Related Art

JP-A-2003-84314 discloses an active matrix electrophoretic display device having a switching transistor and a memory circuit in a pixel. In the display device disclosed in the above-mentioned patent document, an electrophoretic element having a plurality of microcapsules, each containing charged particles, is adhered to an element substrate on which pixel switching transistors and pixels electrodes are formed, and the electrophoretic element is interposed between an opposing substrate provided with an opposing electrode and the element substrate.

The patent document (particularly FIG. 9) also discloses an electrophoretic display device having a structure in which a pixel includes a latch circuit serving as a memory circuit, and a switch circuit.

According to this circuit structure, since it is possible to change a display state among an entirely black image, an entirely white image, and a reversal image while maintaining image data in the latch circuit, it is not needed to drive a driver circuit except for a case of displaying a new image, so that a display can be smoothly performed.

The latch circuit has a transfer inverter and a feedback inverter. Each of the inverters is provided with an N-type transistor and a P-type transistor. When manufacturing the inverters and the pixel switching transistor, semiconductor portions are formed on a substrate and then the semiconductor portions are irradiated with light so that the semiconductor portions are crystallized. In the known crystallization method, the entire pixel is irradiated with pulse-form laser with a band-like irradiation area by division in a plural number of times by moving the pulse-form laser for every pulse.

However, pulses of the pulse-form light such as laser do not have uniform irradiation condition (for example, energy amount) and it is difficult to control the variance of the irradiation conditions among the pulses. For such a reason, the semiconductor portions are irradiated with different pulses of the laser light which have different energy amounts. As a result, the semiconductor portions are crystallized by different degrees and therefore the semiconductor portions have variance in the electric characteristics. In particular, in the case in which the semiconductor portion which constitutes the selection transistor and the semiconductor portions which constitutes the N-type transistor and the P-type transistor of the feedback inverter of the latch circuit have variance in the electrical characteristics, there is a strong chance that malfunction of the latch circuit occurs. Accordingly, a uniform degree of crystallization must be performed with respect to these semiconductor portions.

### SUMMARY

An object of some aspects of the invention is to provide a manufacturing method of an electrophoretic display device, an electrophoretic display device, and an electronic apparatus which can prevent malfunction of a memory circuit from occurring.

According to one aspect of the invention, there is provided a manufacturing method of an electrophoretic display device including a pair of substrates with an electrophoretic element therebetween, the electrophoretic element containing electrophoretic particles therein, and a display portion with a plurality of pixels arranged therein, each pixel including a selection transistor and a latch circuit connected to the selection transistor; the manufacturing method including a semiconductor portion forming process for forming a first semiconductor portion which constitutes the selection transistor and a second semiconductor portion composed of a plurality of transistors which constitutes a feedback inverter of the latch circuit so that the first semiconductor portion and the second semiconductor portion are placed in a straight line form extending in a direction of arrangement of the pixels, and an irradiating process for irradiating the first and second semiconductor portions with pulse-form light along the arrangement of the straight line form.

According to this aspect, the first semiconductor portion which constitutes the selection transistor and the second semiconductor portion composed of a plurality of transistors which constitutes the feedback inverter of the latch circuit are arranged in a straight line form extending in the direction of arrangement of the pixels. Further, the pulse-form light is irradiated on the first and second semiconductor portions along to the straight line form arrangement. Accordingly, the first and second semiconductor portions are irradiated with pulses of the pulse-form light which have almost identical irradiation conditions. Since the irradiation condition of the same pulse of the pulse-form light is uniform, the first and second semiconductor portions are crystallized almost by the same degree, and therefore the electrical characteristics of the first and second portions are almost uniform. With this method, it is possible to prevent the selection transistor and the plurality of transistors which constitutes the feedback inverter from having the variance in the electrical characteristics, and therefore it is possible to the latch circuit from malfunctioning.

In the manufacturing method of an electrophoretic display device, it is preferable that in the semiconductor portion forming process, a plane area serving as a channel region of the selection transistor of the first semiconductor portion and a plane area serving as channel regions of the plurality of selection transistors of the second semiconductor portion are placed in a straight line form in the direction of arrangement direction of the pixels.

According to this aspect, when forming the semiconductor portions, the plane area serving as the channel region of the selection transistor of the first semiconductor portion, and a plane area serving as the channel regions of the plurality of transistors of the second semiconductor portion are arranged in a straight line form extending in the arrangement direction of the pixels. Accordingly, the channel regions of the first and second semiconductor portions can be crystallized almost by the same degree.

In the manufacturing method of an electrophoretic display device, it is preferable that in the semiconductor portion forming process, the first and second semiconductor portions are formed at an area, which is irradiated with the pulse-form light in the irradiating process.

According to this aspect, when forming the semiconductor portions, the first and second semiconductor portions are formed in the area irradiated with the pulse-form light in the irradiating process which is a post process. Accordingly, it is possible to surely irradiate the entire portion of the first and second semiconductor portions with the pulse-form light. With such a method, it is possible to crystallize the entire area of each of the semiconductor portions by irradiating the pulse-form light by a single pulse, and therefore it is possible to shorten the time of the pulse-form light irradiating process.

In the manufacturing method of an electrophoretic display device, it is preferable that in the semiconductor portion forming process, the first semiconductor portions and the second semiconductor portions of the plurality of pixels are placed in a straight line form extending in the direction of arrangement of the pixels.

According to this aspect, when forming the semiconductor portions, the first and second semiconductor portions of the plurality of pixels are placed in the strait line form extending along the arrangement of the pixels. Accordingly, it is possible to prevent malfunction of the latch circuits of the plurality of pixels from occurring. With this method, it is possible to manufacture the highly reliable electrophoretic display device.

In the manufacturing method of an electrophoretic display device, it is preferable that the plurality of pixels is a plurality of pixels belonging to one scan line or one data line of scan lines or data lines which extend in the display portion.

According to this aspect, since the plurality of pixels is a plurality of pixels belonging to one scan line or one data line of scan lines or data lines extending in the display portion, it is possible to prevent malfunction of the latch circuits of the plurality of pixels belonging to one scan line or one data line from occurring.

According to another aspect of the invention, there is provided an electrophoretic display device including a pair of substrates with an electrophoretic element interposed therebetween, the electrophoretic element containing electrophoretic particles, and a display portion with a plurality of pixels arranged therein, in which each pixel includes a selection transistor and a latch circuit connected to the selection transistor, and in which a first semiconductor portion which constitutes the selection transistor and a second semiconductor portion of a plurality of transistors which constitutes a feedback inverter of the latch circuit are arranged in a straight line form extending in a direction of arrangement of the pixels.

According to this aspect, since the first semiconductor portion constituting the selection transistor and the second semiconductor portion of the plurality of transistors constituting the feedback inverter of the latch circuit are placed in a straight line form extending in the arrangement direction of the pixels, it is possible to crystallize the first and second semiconductor portions uniform by the band-shaped pulse-form light when forming the first and second semiconductor portions.

In the manufacturing method of an electrophoretic display device, it is preferable that the first and second semiconductor portions of the plurality of pixels are placed in a straight line form extending in the direction of arrangement of the pixels.

According to this aspect, since the first and second semiconductor portions of the plurality of the pixels are arranged in a straight line form extending in the arrangement direction of the pixels, it is possible to prevent malfunction of the latch circuits of the plurality of pixels from occurring. With this structure, it is possible to obtain the high reliable electrophoretic display device.

In the manufacturing method of an electrophoretic display device, it is preferable that the plurality of pixels is a plurality of pixels belonging to one scan line or one data line of scan lines or data lines which extend in the display portion.

According to this aspect, since the plurality of pixels is a plurality of pixels belonging to one scan line or one data line of scan lines or data lines extending in the display portion, it is possible to prevent malfunction of the latch circuits of the plurality of pixels belonging to one scan line or one data line from occurring.

According to a further aspect of the invention there is provided an electronic apparatus including one of the above-mentioned electrophoretic display devices.

According to this aspect, since it is possible to prevent malfunction of the latch circuits from occurring and it is possible to mount the highly reliable electrophoretic display device, it is possible to obtain an electronic apparatus with a highly reliable display portion.

### BRIEF DESCRIPTION OF THE DRAWINGS

The invention will be described with reference to the accompanying drawings, wherein like numbers reference like elements.

FIG. 1 is a schematic view illustrating an electrophoretic display device according to a first embodiment of the invention.

FIG. 2 is a circuit diagram illustrating a pixel of the electrophoretic display device according to the first embodiment.

FIG. 3 is a partial sectional view illustrating the electrophoretic display device according to the first embodiment.

FIG. 4 is a sectional view illustrating a microcapsule of the electrophoretic display device according to the first embodiment.

FIG. 5 is a plan view illustrating a structure of a single pixel of the electrophoretic display device according to the first embodiment.

FIG. 6 is a view illustrating manufacturing sequence of an electrophoretic display device.

FIG. 7 is a circuit diagram illustrating a pixel of an electrophoretic display device according to a second embodiment of the invention.

FIG. 8 is a plane view illustrating a single pixel of the electrophoretic display device according to the second embodiment.

FIG. 9 is a circuit diagram illustrating a pixel of an electrophoretic display device according to a third embodiment of the invention.

FIG. 10 is a plan view illustrating a single pixel of the electrophoretic display device according to the third embodiment.

FIG. 11 is a circuit diagram illustrating a pixel of an electrophoretic display device according to a fourth embodiment of the invention.

FIG. 12 is a plan view illustrating a single pixel of the electrophoretic display device according to the fourth embodiment of the invention.

FIG. 13 is a circuit diagram illustrating a pixel of an electrophoretic display device according to one modification of the invention.

### DESCRIPTION OF EXEMPLARY EMBODIMENTS

Hereinafter, embodiments of the invention will be described with reference to the accompanying drawings. In this embodiment, an electrophoretic display device driven by an active matrix drive method will be exemplified. In the figures, scales and numbers are differently set from real scales and numbers to help people better identify each element.

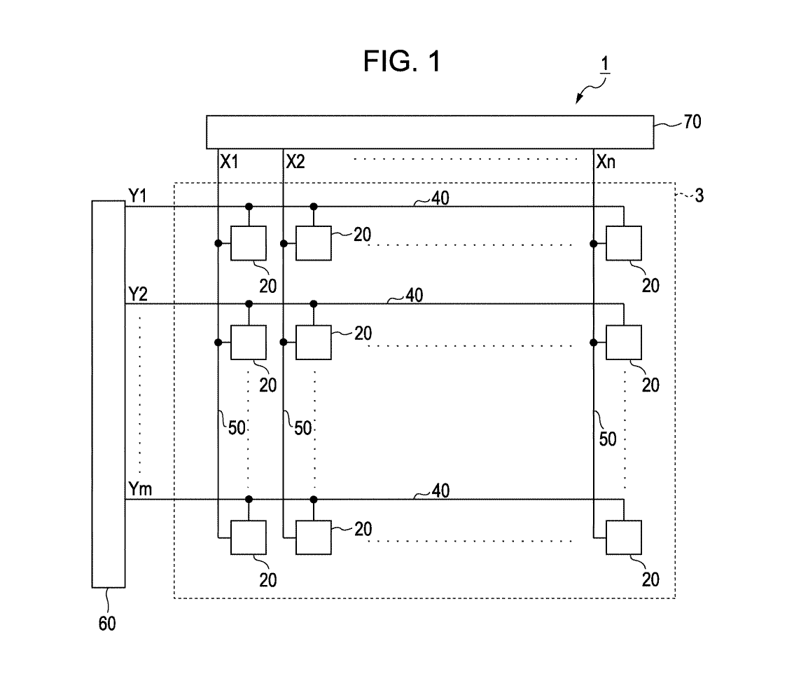

FIG. 1 shows an overall structure of an electrophoretic display device 1 according to a first embodiment of the invention. The electrophoretic display device 1 includes a display portion 3 in which a plurality of pixels 20 is arranged, a scan line drive circuit 60, and a data line drive circuit 70.

A plurality of scan lines 40 (Y1, Y2, . . . , and Ym) extending from the scan line drive circuit 60 and a plurality of data lines 50 (X1, X2, . . . , and Xn) extending from the data line drive circuit 70 are formed in the display portion 3. Each of the pixels 20 is placed corresponding to an intersection of each of the scan lines 40 and each of the data lines 50 and each of the pixels 20 is connected to each of the scan lines 40 and each of the data line 50.

Although illustration is omitted in the figure, a common power source modulation circuit and a controller are placed around the display portion 3 in addition to the scan line drive circuit 60 and the data line drive circuit 70. The controller comprehensively controls each of the circuits on the basis of image data and synchronous signals supplied from an upper-layer device.

The common power source modulation circuit performs electrical connection and disconnection (high impedance state) between wirings as well as controls the controller and produces various signals to be supplied to the wirings.

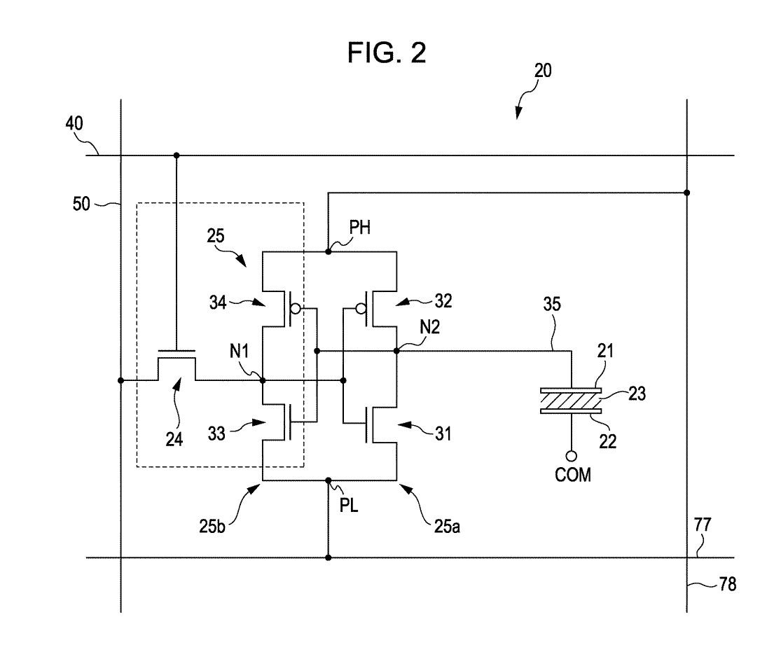

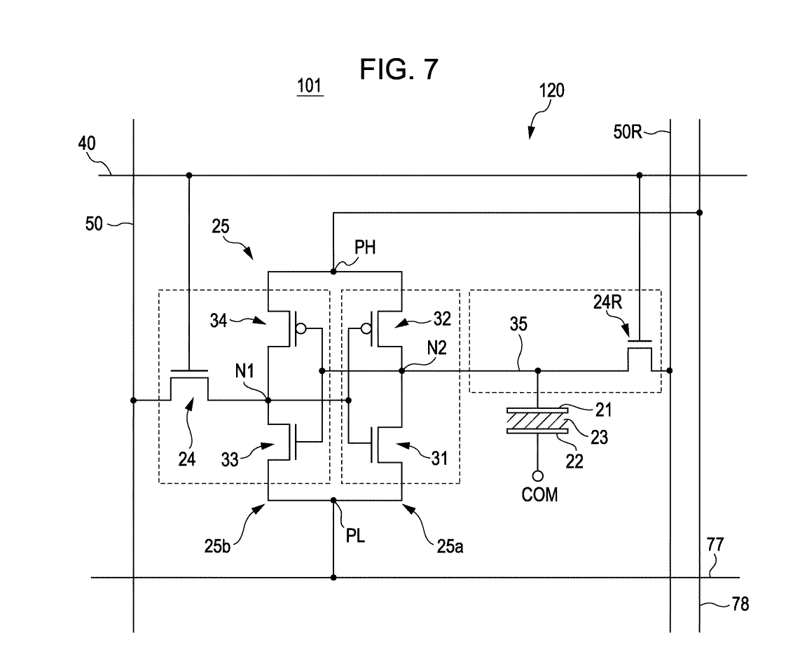

Each of the pixels 20 is connected to the scan line 40 and the data line 50. According to the circuit structure of FIG. 2, each of the pixels 20 is connected to a high potential power source line and a low potential power source line in addition to the scan line 40 and the data line 50. According to the circuit structure of FIG. 7, the pixel 20 is further connected to a reversed data line 50R.

FIG. 2 shows the circuit structure of the pixel 20. As shown in FIG. 2, the pixel 20 includes a selection transistor 24, a latch circuit (memory circuit) 25, a pixel electrode 21, a common electrode 22, and an electrophoretic element 23.

The selection transistor 24 is a field effect N-type transistor. A gate terminal of the selection transistor 24 is connected to the scan line 40, a source terminal of the selection transistor 24 is connected to the data line 50, and a drain terminal of the selection transistor 24 is connected to an input terminal N1 of the latch circuit 25.

The latch circuit 25 includes a transfer inverter 25a and a feedback inverter 25b and is a circuit corresponding to a static random access memory (SRAM) cell.

An output terminal of the transfer inverter 25a is connected to an input terminal of the feed back inverter 25b, and an output terminal of the feedback inverter 25b is connected to an input terminal of the transfer inverter 25a. That is, the transfer inverter 25a and the feedback inverter 25b form a loop structure in which the input terminal of each of them is connected to the output terminal of the opponent. The input terminal of the transfer inverter 25a (the output terminal of the feedback inverter 25b) becomes a data input terminal N1 of the latch circuit 25, the output terminal of the transfer inverter 25a (the input terminal of the feedback inverter 25b) becomes a data output terminal N2 of the latch circuit 25. A high potential power source terminal PH of the latch circuit 25 is connected to a high potential power source line 78, and a low potential power source terminal PL is connected to a low potential power source line 77.

The transfer inverter 25a includes an N-type transistor 31 and a P-type transistor 32. Gate terminals of the N-type transistor 31 and the P-type transistor 32 are connected to the input terminal N1 of the latch circuit 25. A source terminal and a drain terminal of the N-type transistor 31 are connected the low potential power source line 77 and the output terminal N2, respectively. A source terminal and a drain terminal of the P-type transistor 32 are connected to the high potential power source line 78 and the output terminal N2, respectively.

The feedback inverter 25b includes an N-type transistor (first transistor) 33 and a P-type transistor (second transistor) 34. Gate terminals of the N-type transistor 33 and the P-type transistor 34 are connected to the output terminal N2 of the latch circuit 25 (drain terminals of the N-type transistor 31 and the P-type transistor 32). A source terminal and a drain terminal of the N-type transistor 33 are connected to the low potential power source line 77 and the input terminal N1, respectively. A source terminal and a drain terminal of the P-type transistor 34 are connected to the high potential power source line 78 and the input terminal N1, respectively. The output terminal N2 is connected to a pixel electrode 21 via a wiring 35.

In the pixel 20 having the above-described structure, when an image signal with a low level is input to the latch circuit 25, the input terminal N1 becomes a low level and the output terminal N2 becomes a high level. Accordingly, the pixel electrode 21 connected to the output terminal N2 is applied with the high level. On the other hand, when an image signal with a high level is input to the latch circuit 25, the input terminal N1 becomes the high level and the output terminal N2 becomes the low level. Accordingly, the pixel electrode 21 connected to the output terminal N2 is applied with the low level. In this manner, the pixel electrode 21 is applied with a potential depending on image data (image signal) input to the latch circuit 25 via the wiring 35.

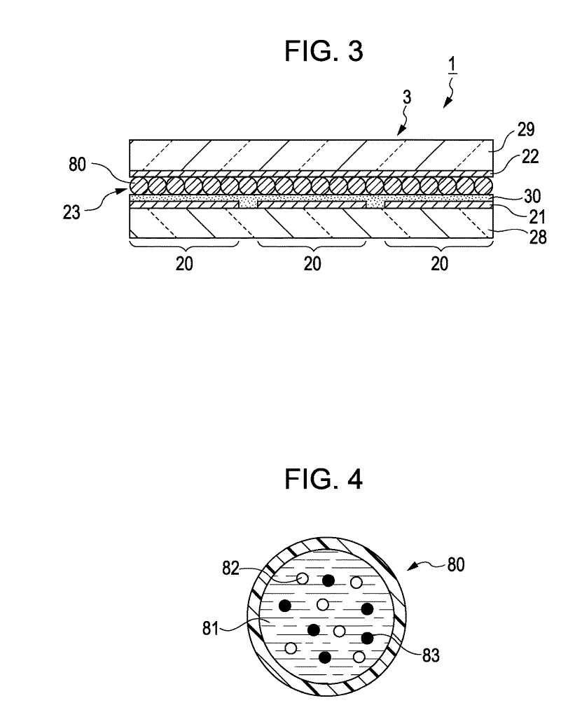

FIG. 3 shows part of the electrophoretic display device, the display portion 3. The electrophoretic display device 1 has a structure in which an electrophoretic element 23, composed of a plurality of microcapsules 80 arranged in the electrophoretic element 23, is interposed between an element substrate 28 and an opposing element 29.

In the display portion 3, a plurality of pixel electrodes 21 is arranged at the electrophoretic element 23 side of the element substrate 28, and the electrophoretic element 23 is adhered to the pixel electrodes 21 via an adhesive layer 30. A common electrode 22 having a panel shape and opposing to the pixel electrodes 21 is formed at the electrophoretic element 23 side of the opposing substrate 29. The electrophoretic element 23 is provided on the common electrode 22.

The element substrate 28 is a substrate made of glass or plastic and may not be a transparent substrate because it is placed on the opposite side of an image displaying surface. Although illustration is omitted in the figure, the scan lines 40, the data lines 50, the selection transistors 24, and the latch circuits 25 shown in FIG. 1 and FIG. 2 are formed between the pixel electrodes 21 and the element substrate 28.

The opposing substrate 29 is a substrate made of glass or plastic and may be a transparent substrate because it is placed at the image displaying surface side. The common electrode 22 formed on the opposing substrate 29 is formed using a transparent conductive material, such as magnesium-silver MgAg, indium tin oxide (ITO), indium zirconium oxide (IZO), etc.

The electrophoretic element 23 is formed on the opposing substrate 29 beforehand, and it is generally treated as an electrophoretic sheet along with the adhesive layer 30. Release paper for protection is attached to the adhesive layer 30.

In the manufacturing process, the display portion 3 is formed by attaching the electrophoretic sheet from which release paper is peeled to the element substrate 28 which is separately prepared and is provided with the pixel electrodes 21 and the circuits. Accordingly, the adhesive sheet 30 is present only on the pixel electrode 21 side.

FIG. 4 is a schematic sectional view illustrating the microcapsule 80. The microcapsule 80 has a grain size of 50 μm and is a spherical body containing a dispersion medium 81, a plurality of white particles (electrophoretic particles) 82, and a plurality of black particles (electrophoretic particles) 83 therein. The microcapsule 80, as shown in FIG. 3, is interposed between the pixel electrode 21 and the common electrode 22, and a single microcapsule 80 or a plurality of microcapsules 80 is placed in a single pixel 20.

The shell (wall film) of the microcapsule 80 is made of an acryl resin, such as polymethylmethacrylate and polyethylmethacrylate, or a transparent polymer resin, such as urea resin and Arabic gum.

The dispersion medium 81 is a liquid which disperses the white particles 82 and the black particles 83 in the microcapsule 80. The dispersion medium 81 may be water, alcohol-based solvent (methanol, ethanol, isopropanol, butanol, octanol, and methyl cellosolve), a variety of esters (acetic ethyl and acetic butyl), ketone (acetone, methylethylketone, and methylisobutylketone), aliphatic hydrocarbon (pentane, hexane, and octane), cycloaliphatic hydrocarbon (cyclohexane and methylcyclohexane), aromatic hydrocarbon (benzene, toluene, a benzene derivative having a long-chain alkyl group (xylene, hexylbenzene, heptane, hebuthylbenzene, octylbenzene, nonylbenzene, decylbenzene, undecylbenzene, dodecylbenzene, tridecylebenzene, and tetradecylbenzene), halogenated hydrocarbon (methylene chloride, chloroform, carbon tetrachloride, and 1,2-dichloroethane), carboxylate, and other kinds of oils. These materials can be used in the form of a single material or a mixture. Further, surfactant may be added to the above.

The white particles 82 are particles (polymer or colloid) composed of white pigments, such as titanium dioxide, zinc oxide, and antimony trioxide, and are charged negative. The black particles 83 are particles (polymer or colloid) composed of black pigments, such as aniline black and carbon black, and are charged positive.

If it is necessary, a charge control agent composed of electrolyte, surfactant agent, metallic soap, resin, rubber, oil, varnish, and particles such as compounds; a dispersant agent, such as a titanium-based coupling agent, an aluminum-based coupling agent, a silane-based coupling agent; a lubricant; and a stabilizer can be added to these pigments.

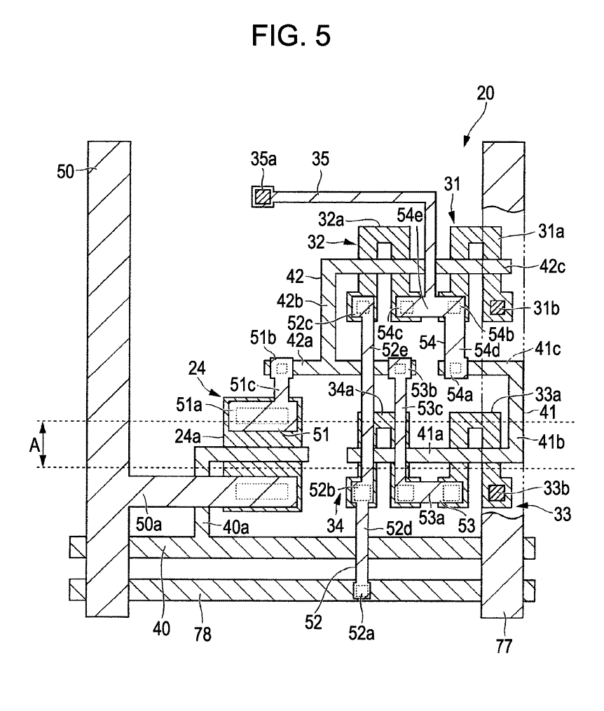

FIG. 5 shows a detailed structure of the single pixel 20 of the electrophoretic display device 1 according to this embodiment. As shown in FIG. 5, the pixel 20 is provided to a rectangular-shaped area in a plan view. The pixel 20 is surrounded by four global wirings—the scan line 40 formed along a lower edge of the pixel, the data line 50 formed along a left edge of the pixel, the low potential power source line 77 formed along a right edge of the pixel, and the high potential power source lines 78 formed in parallel with the scan lines 40 at the lower edge of the pixel. In FIG. 5, part of the low potential power source line 77 is cut away so that a portion of the pixel which is disposed under the low potential power source line 77 is visible.

The inside of the pixel 20 surrounded by the four global wirings is provided with a semiconductor portion and a wiring layer. The semiconductor portion and the wiring layer 3 have a three-layered structured. A first layer, the lowermost layer, is provided with five semiconductor portions including a semiconductor portion 24a, a semiconductor portion 31a, a semiconductor portion 32a, a semiconductor portion 33a, and a semiconductor portion 34a. A second layer, the middle layer, is provided with the scan line 40 and the high potential power source line 78. A third layer, the uppermost layer, is provided with the data line 50 and the low potential power source line 77. The second and third layers are provided with a plurality of wirings in addition to the above-mentioned wirings.

The semiconductor portion 24a is an area which forms the selection transistor 24 of the circuits. The semiconductor portion 24a has a rectangular shape in a plan view which is relatively longer in a vertical direction of the figure. A midway portion in the vertical direction of the figure forms a channel region, a lower portion of the figure forms a source region, and an upper portion of the figure forms a drain region.

The semiconductor portion 31a forms the N-type transistor 31 of the transfer inverter 25a of the latch circuit 25. The semiconductor portion 31a has a reversed letter U shape in plan view. Two strait line-shaped portions of the reversed letter U area serve as channel regions, an end portion of the reversed letter U shape at the right side of the figure serves as a source region, and an end portion of the reversed letter U shape at the left side of the figure serves as a drain region. The straight line-shaped portion and the right side end portion of the semiconductor portion 31a of the figure are placed to overlap the low potential power source line 77 in a plan view. These portions and the low potential power source line 77 are connected to each other via a contact hole 31b.

The semiconductor portion 32a is a semiconductor portion of the P-type transistor 32 of the transfer inverter 25a. The semiconductor portion 32a has a reversed letter U shape in a plan view like the semiconductor portion 31a. Further, two straight line-shaped portions of the reversed letter U area serve as channel regions, an end portion of the reversed letter U area at the left side of the figure serves as a source region, and an end portion of the reversed letter U area at the right side of the figure serves as a drain region.

The semiconductor portion 33a is a semiconductor portion constituting the N-type transistor 33 of the feedback inverter 25b. The semiconductor portion 33a has a reversed letter U shape in a plan view. Two straight line-shaped portions of the reversed letter U area serve as channel regions, an end portion of the reversed letter U area at the right side of the figure serves as a source region, and an end portion of the reversed letter U area at the left side of the figure serves as a drain region. The straight line portion and the end portion of the semiconductor portion 33a at the right side of the figure are placed to overlap the low potential power source line 77, and these portions and the low potential power source line 77 are connected to each other via a contact hole 33b.

The semiconductor portion 34a is a semiconductor portion constituting the P-type transistor of the feedback inverter 25b. The semiconductor portion 34a has a reversed letter U shape in a plan view. Two straight line portions of the reversed letter U shape serve as channel regions, an end portion of the straight line portion at the left side of the figure serves as a source region, and an end portion of the straight line portion at the right side of the figure serves as a drain region.

Of these five semiconductor portions, the semiconductor portions 24a, 34a, and 33a are placed in a row in this order over a way from the left side to the right side of the figure at the lower edge side (scan line 40 side) of the pixel, and a portion of each of these portions overlaps a predetermined area A (an area disposed between two dashed lines which are in parallel with each other in the figure). The predetermined area A indicates an irradiation range that can be irradiated by a single pulse of pulse-form laser (pulse-form light) when forming each semiconductor portion.

The pixel 20 is a single pixel (see FIG. 1) of the pixels arranged in a lattice form. Further, the semiconductor portions in left and right side neighboring pixels are also arranged in a straight line form. In greater detail, the semiconductor portions 24a, 34a, and 33a in each of the pixels formed along the scan line 40 are arranged in a straight line form in an arrangement direction of the pixels.

The arrangement direction of the pixel portions may be an extended direction of the data line 50. In this case, the predetermined area A may become the extended direction of the data line 50, the channel regions of the semiconductor portions may be placed to overlap the predetermined area.

The order of the arrangement of the semiconductor portions 24a, 34a, and 33a is not limited to the example shown in the figure. As long as the semiconductor portions 24a, 34a, and 33a are placed in a straight line form extending in the arrangement direction of the pixels, the arrangement order does not matter. In the example shown in FIG. 5, the semiconductor portion 24a constituting the selection transistor 24 is placed closest to the data line 50. Further, the N-type transistor 33b connected to the low potential power source line 77 is placed closest to the low potential power source line 77.

The semiconductor portions 31a and 32a are arranged in a horizontal direction at an upper side of the pixel in the figure. The arrangement direction of the semiconductor portions 31a and 32a is not limited to the horizontal direction of the figure. For example, the semiconductor portions 31a and 32a may be placed in the vertical direction or in other directions.

The second layer is provided with the wirings 40a, 41, and 42. The above-described scan lines 40 and the high potential power source line 78 are provided in the second layer. The wirings 40a branch off upward from the scan lines 40. A portion of each of the wirings 40a overlaps the channel region of the semiconductor portion 24a in a plan view. A portion of each of the wirings 40a which overlaps the channel region of the semiconductor portion 24a in a plan view functions as a gate terminal of the selection transistor 24.

The wiring 41 includes a wiring portion 41a extending in the horizontal direction of the figure so that it crosses the semiconductor portions 34a and 33a, a wiring portion 41b extending from a right end of the wiring portion 41a formed along the low potential power source line 77 and detouring at the upper side of the figure, and a wiring portion 41c detouring from an upper end of the wiring portion 41b toward the left side of the figure and protruding into the pixel 20.

The wiring 42 includes a wiring portion 42a disposed at a midway portion of the pixel 20 in the vertical direction of the figure and extending in the horizontal direction of the figure, a wiring portion 42b branching off upward from the wiring portion 42a, and a wiring portion 42c extending from an upper end of the wiring portion 42b toward the right side of the figure. The wiring portion 42c overlaps the channel regions of the semiconductor portions 31a and 32a in a plan view. The wiring portion 42c functions as gate terminals of the N-type transistor 31 and the P-type transistor 32 of the transfer inverter 25a.

The third layer is provided with wirings 50a, 51, 52, 53, and 54. Further, the above-mentioned data line 50 and the low potential power source line 77 are also provided to the third layer. The wiring 50a is a wiring branching off from the data line 50 toward the left side of the figure and is connected to the source region of the semiconductor portion 24a via a contact hole (a rectangular portion indicated by a dashed line of the figure) at a leading end of the wiring 50a.

The wiring 51 includes a wiring portion 51a overlapping a drain region of the semiconductor portion 24a in a plan view, a wiring portion 51b overlapping the left end portion of the wiring 42a in the figure in a plan view, and a wiring portion 51c connected between the wiring portions 51a and 52b. The wiring portion 51a is connected to the drain region of the semiconductor portion 24a via a contact hole. The wiring portion 51b is connected to the wiring portion 42a via a contact hole.

The wiring 52 is a wiring extending in the vertical direction of the figure at a midway portion of the pixel 20 in the horizontal direction. The wiring 52 includes a wiring portion 52a overlapping the high potential power source line 78 in a plan view, a wiring portion 52b overlapping the source region of the semiconductor portion 34a in a plan view, a wiring portion 52c overlapping the source region of the semiconductor portion 32a in a plan view, a wiring portion 52d connected between the wiring portion 52a and the wiring portion 52b, and a wiring portion 52e connected between the wiring portion 52b and the wiring portion 52c. The wiring portion 52a is connected to the high potential power source line 78 via a contact hole. The wiring portion 52b is connected to the source region of the semiconductor portion 34a via a contact hole. The wiring portion 52c is connected to the source region of the semiconductor portion 32a via a contact hole.

The wiring 53 is a wiring having a letter L shape in a plan view and is disposed at a lower right portion of the pixel 20. The wiring 53 includes a wiring portion 53a formed extending in the horizontal direction of the figure over a way from the semiconductor portion 34a to the semiconductor portion 33a, a wiring portion 53b overlapping a right end portion of the wiring portion 42a in the figure, and a wiring portion 53c connected between the wiring portion 53a and the wiring portion 53b. A left end portion of the wiring portion 53a is placed overlapping the drain region of the semiconductor portion 34a in a plan view, and is connected to the drain region of the semiconductor portion 34a via a contact hole. A right end portion of the wiring portion 53a is placed overlapping the source region of the semiconductor portion 33a in a plan view and is connected to the source region of the semiconductor portion 33a via a contact hole. The wiring portion 52b is connected to the right end portion of the wiring portion 42a via a contact hole.

The wiring 54 has a letter L shape in a plan view and is disposed at the right side of the pixel 20 in the figure. The wiring 54 includes a wiring portion 54a overlapping a protruding portion of the wiring portion 41c in a plan view, a wiring portion 54b overlapping the drain region of the semiconductor portion 31a in a plan view, a wiring portion 54c overlapping the drain region of the semiconductor portion 32a in a plan view, a wiring portion 54d connected between the wiring portion 54a and the wiring portion 54b, and a wiring portion 51e connected between the wiring portion 54b and the wiring portion 54c. The wiring portion 54a is connected to the wiring portion 41c via a contact hole. The wiring portion 54b is connected to the drain region of the semiconductor portion 31a via a contact hole. The wiring portion 54c is connected to the drain region of the semiconductor portion 32a via a contact hole. The wiring portion 35 branches off from the wiring portion 54e and a leading end portion of the wiring portion 35 is connected to the pixel electrode 21 via a contact hole 35a.

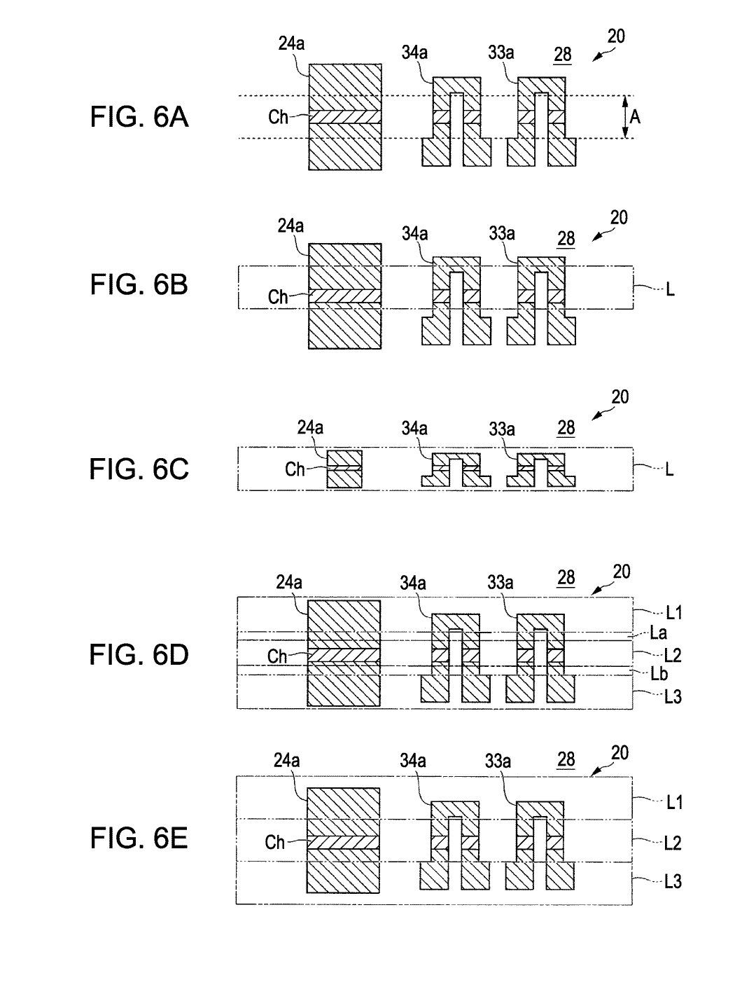

FIGS. 6A to 6E show process steps of manufacturing the electrophoretic display 1. When manufacturing the electrophoretic display 1 having the above structure, the semiconductor portions 24a, 31a, 32a, 33a, and 34a formed in the first layer within the pixel 20 on the element substrate 28 (semiconductor portion forming process). These semiconductor portions are irradiated with the pulse-form laser and thus are crystallized (irradiating process). The irradiation range irradiated with a single pulse of the pulse-form laser has the same width as a vertical-direction size of the predetermined area A.

As shown in FIG. 6A, in the semiconductor portion forming process according to this embodiment, the semiconductor portion 24a of the selection transistor 24, and the semiconductor portion 33a of the N-type transistor 33 and the semiconductor portion 34a of the P-type transistor 34 of the feedback inverter 25b are placed in a row in a straight line form within a predetermined area A of the pixel 20 which has the same size as the irradiation area that can be irradiated with a single pulse of the pulse-form laser. Right-side hatch portions of the semiconductor portions 24a, 33a, and 34a at a midway position in the vertical direction are channel regions Ch of the transistors.

Since the semiconductor portions 24a, 33a, and 34a are formed as described above, as shown in FIG. 6B, the three semiconductor portions 24a, 33a, and 34a can be simultaneously irradiated with the same pulse of the pulse-form laser L in the irradiating process. The three semiconductor portions 24a, 33a, and 34a are crystallized with the irradiation using the pulse-form laser L by the same degree.

As shown in FIG. 6C, three semiconductor portions 24a, 33a, and 34a are formed to fall in a size of the entire area of the irradiation range of the pulse-form laser L, and the entire area of the three semiconductor portions 24a, 33a, and 34a may be irradiated with the same pulse of the pulse-form laser.

Alternatively, the semiconductor portions 24a, 33a, and 34a may be irradiated with the pulse-form laser by division in a plural number of times. As shown in FIG. 6D, the irradiation is performed in a manner such that irradiation position of the pulse-form laser L is moved for each pulse so that irradiation areas of the pulse-form laser L overlap one another on the semiconductor portions 24a, 33a, and 34a. In FIG. 6D, the irradiation position is moved in a downward direction of the figure three times and the three times of irradiation are performed with laser components L1, L2, and L3. The pulse-form laser component L1 and the pulse-form laser component L2 overlap each other at an area La, and the pulse-form laser component L2 and the pulse-form laser component L3 overlap each other at an area Lb.

As shown in FIG. 6E, the irradiation is performed so that the borders of the pulse-form laser components overlap each other. In FIG. 6E, the irradiation is performed by dividing the pulse-form laser into laser light components L1, L2, and L3 while moving the irradiation positions of the pulse-form laser L in the downward direction of the figure. An upper edge of the laser light component L2 is adjacent to a lower edge of the laser light component L1, and an upper edge of the laser light component L3 is adjacent to a lower edge of the laser light component L2. Although it is not illustrated, the irradiation may be performed in a manner such that a gap is provided between each of the laser light components L1, L2, and L3.

In this manner, according to this embodiment, a portion of each of the semiconductor portions 24a, 33a, and 34a of the selection transistor 24 and the N-type transistor 33 and the P-type transistor 34 of the feedback inverter 25b is arranged to overlap the predetermined area A within the pixel 20 having the almost same size as the irradiation area irradiated with each unit pulse of the laser light L which is the pulse-form laser. Accordingly, when irradiating the semiconductor portions with the laser light L, it is possible to simultaneously irradiate the semiconductor portions 24a, 33a, and 34a with the same pulse of the laser light L. Since the irradiation condition of the laser light in the same pulse is almost uniform, the semiconductor portions 24a, 33a, and 34a are crystallized by the same degree by the laser light L, and therefore the electrical characteristics of the semiconductor portions 24a, 33a, and 34a are substantially uniform. For such a reason, it is possible to prevent the variance in the electrical characteristics of the selection transistor 24, the N-type transistor 33, and the P-type transistor 34 from occurring, and therefore it is possible to obtain the designed electrical characteristics.

If the selection transistor 24, the N-type transistor 33, and the P-type transistor 34 have the variance in the electrical characteristics thereof, the current flowing across the selection transistor 24 is not sufficient to determine the potential of the data input terminal and therefore the writing to the latch circuit 25 is likely to have a trouble. With this embodiment, it is possible to prevent the variance in the electrical characteristics of the selection transistor 24, the N-type transistor 33, and the P-type transistor 34 from occurring. As a result, since it is possible to obtain the designed electrical characteristic, it is possible to ensure the writing to the latch circuit 25 and to obtain the highly reliable electrophoretic display device 1.

### Second Embodiment

Next, a second embodiment of the invention will be described. An electrophoretic display device 101 according to this embodiment has a structure in which a reversed data line and a selection transistor connected to the reversed data line are added to the pixel 20 of the first embodiment shown in FIG. 2 and FIG. 5. Accordingly, in the drawings mentioned in the following description, common elements between the pixel 20 of FIG. 2 and FIG. 5 and the pixel 20 are referenced with like references and therefore description of those elements will be omitted.

FIG. 7 shows a circuit structure of a pixel 120 of the electrophoretic display device 101 and is a view corresponding to FIG. 2 according to the first embodiment. As shown in FIG. 7, the pixel 120 includes a selection transistor 24, a selection transistor 24R, a latch circuit (memory circuit) 25, a pixel electrode 21, a common electrode 22, and an electrophoretic element 23. The structure of the selection transistor 24 and the latch circuit 25 according to the second embodiment is the same as that of the structure of the selection transistor 24 and the latch circuit 25 according to the first embodiment. Accordingly, description thereof will be omitted.

The selection transistor 24R is a field effect type N-type transistor like the selection transistor 24. A gate terminal, a source terminal, and a drain terminal of the selection transistor 24R are connected to the scan line 40, the reversed data line 50R, and an output terminal N2 of the latch circuit 25, respectively. Accordingly, a signal from the selection transistor 24R is input to the output terminal N2.

A signal which is reverse to the signal input to the data line 50 is input to the reversed data line 50R. That is, when a high level is input to the data line 50, a low level is input to the reversed data line 50R. When the low level is input to the data line 50, the high level is input to the reversed data line 50R.

Since gate terminals of the selection transistors 24 and 24R are connected to the common scan line 40, a signal from the data line 50 is simultaneously input to the selection transistors 24 and 24R.

In the pixel 120 having the above-described structure, when the low level from the selection transistor 24 is input to the latch circuit 25, an input terminal N1 becomes the low level and the output terminal N2 becomes the high level. At this time, the high level from the selection transistor 24R is input to the output terminal N2, and the low level is output to the inter terminal N1.

When the high level from the selection transistor 24 is input to the input terminal N1, the output terminal N2 becomes the low level. At this time, the low level from the selection transistor 24R is input to the output terminal N2 and the high level is output to the input terminal N2. In this manner, according to the circuit structure of FIG. 7, the writing is performed by two selection transistors and it is possible to more surely write the data in comparison with the circuit of FIG. 2.

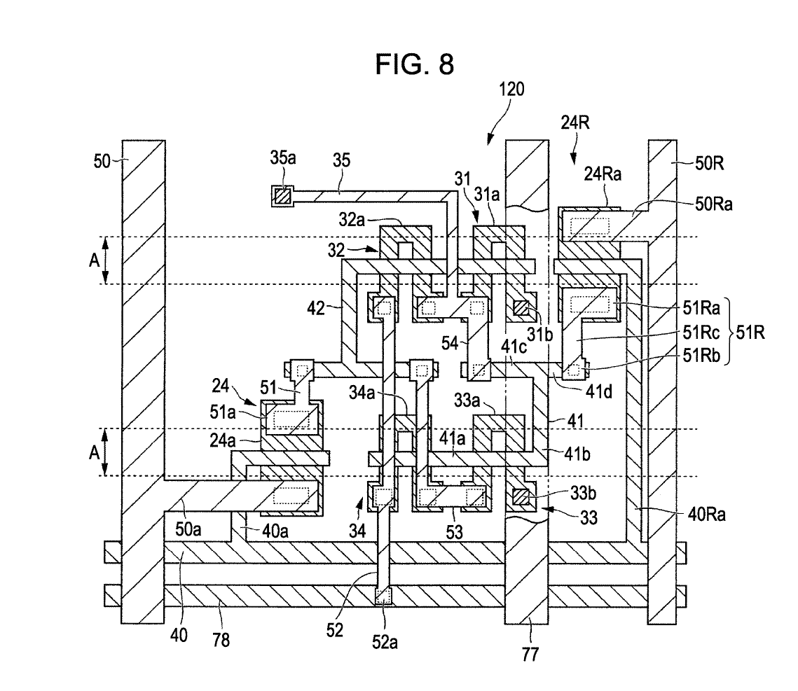

FIG. 8 shows an overall structure of the pixel 120 in a plan view and is a view corresponding to FIG. 5 according to the first embodiment. As shown in FIG. 8, the pixel 120 is rectangular in a plan view. Like the first embodiment, the pixel 120 is surrounded by the scan line 40 formed along a lower edge thereof, the data line 50 formed along a left edge thereof, the low potential power source line 77 formed along a right edge thereof, and the high potential power source line 78 formed in parallel with the scan line 40 at the lower edge of the pixel 120. In addition to these global wirings, a predetermined space is provided between the right edge of the pixel 120 and the low potential power source line 77, and the reversed data line 50R is formed in the space. In FIG. 8, part of the low potential power source line 77 is cut away so that an underneath portion of the low potential power source line 77 is clearly visible.

Semiconductor portions and wiring layers are formed in the pixel 120 surrounded by the five global wirings and have a three-layered structure. A first layer, the lowermost layer, is provided with semiconductor portions 24a, 31a, 32a, 33a, and 34a in addition to the semiconductor portion 24Ra. That is, six semiconductor portions are provided to the first layer.

The semiconductor portion 24Ra constitutes the selection transistor 24R in the circuit. The semiconductor portion 24Ra has a rectangular shape which is relatively longer in a vertical direction of the figure in a plan view. A midway portion of the semiconductor portion 24Ra in the vertical direction serves as a channel region, and an upper portion and a lower portion of the semiconductor portion 24Ra serve as a source region and a drain region, respectively.

Of the six semiconductor portions, like the first embodiment, the semiconductor portions 24a, 34a, and 33a are placed in the pixel and arranged in this order at the lower edge side of the figure over a way from the left side to the right side of the figure, and a portion of each of the semiconductor portions 24a, 34a, and 33a overlaps a predetermined area A (an area between two dashed lines which are in parallel with each other in the figure). The predetermined area A is an irradiation range irradiated by a single pulse of pulse-form laser (pulse-form light) used when forming the semiconductor portions.

In this embodiment, the other semiconductor portions 32a, 31a, and 24Ra are also placed in the pixel and arranged in a row in this order over a way from the left side to the right side of the figure at the upper edge side of the pixel in addition to the above three semiconductor portions. Further, a portion of each of the semiconductor portions overlaps the predetermined area A.

The arrangement order of the semiconductor portions 32a, 31a, and 24Ra is not limited to the example shown in the figure. That is, alternatively the semiconductor portions 32a, 31a, and 24Ra may be arranged in other orders as long as they are placed in a strait line extending in a direction of arrangement of the pixels. In the example shown in FIG. 8, the semiconductor portion 24Ra constituting the selection transistor 24R is placed closest to the reversed data line 50R. The N-type transistor 31b connected to the low potential power source line 77 is placed closest to the low potential power source line 77.

A second layer is provided with a wiring 40Ra in addition to the wirings 40a, 41, and 42. The wiring 40Ra branches off from the scan line 40 and extends upward in the figure at a lower right side of the pixel 120, and a portion of the wiring portion 40Ra overlaps the channel region of the semiconductor portion 24Ra in a plan view. A portion of the wiring 40Ra which overlaps the channel region of the semiconductor portion 24Ra functions as the gate terminal of the selection transistor 24R.

With this embodiment, the wiring 41 includes a wiring portion 41d in addition to wiring portions 41a, 41b, and 41c. The wiring portion 41d is disposed so as to extend from an upper end of the wiring portion 41b toward the right side of the figure, i.e. to extend outward from the pixel 20.

A third layer is provided with a wiring 50Ra and a wiring 51R in addition to wirings 50a, 51, 52, 53, and 54. The wiring 50Ra branches off from the reversed data line 50R toward the left side of the figure. A leading end portion of the wiring 50Ra is connected to a source region of the semiconductor portion 24Ra via a contact hole (a rectangular portion drawn by a dashed line in the figure). The wiring 51R includes a wiring portion 51Ra overlapping a drain region of the semiconductor portion 24Ra in a plan view, a wiring portion 51Rb overlapping the wiring 41d disposed at a right end portion of the figure in a plan view, and a wiring portion 51Rc connected between the wiring portion 51Ra and the wiring portion 51Rb. The wiring portion 51Ra is connected to the drain region of the semiconductor portion 24Ra via a contact hole. The wiring portion 51Rb is connected to the wiring portion 41d via a contact hole.

When manufacturing the electrophoretic display device 101, the first layer within the pixel 120 on the element substrate is provided with the semiconductor portions 24a, 31a, 32a, 33a, 34a, and 24Ra (semiconductor portion forming process), and these semiconductor portions are crystallized by irradiation using the pulse-form laser (irradiating process). A size of an irradiation range for a single pulse of the pulse-form laser is the same as a width of the predetermined area A in the vertical direction of the figure.

With this embodiment, in the semiconductor portion forming process, the semiconductor portion 24a of the selection transistor 24, the semiconductor portion 33a of the N-type transistor 33 of the feedback inverter 25b, and the semiconductor portion 34a of the P-type transistor 34 of the feedback inverter 25b are formed in a low in the predetermined area within the pixel 120 which has almost the same size as an irradiation area irradiated with a single pulse of the pulse-form laser.

The semiconductor portion 32a of the P-type transistor 32 of the transfer inverter 25a, the semiconductor portion 31a of the N-type transistor 31, and the semiconductor portion 24Ra of the selection transistor 24R are formed in a row in the reset of the predetermined area.

A group of three transistors of the semiconductor portions 24a, 33a, and 34a and a group of three transistors of the semiconductor portions 32a, 31a, and 24Ra are formed in the above-described manner. Accordingly, three semiconductor portions 24a, 33a, and 34a in a group and three semiconductor portions 32a, 31a, and 24Ra in a group can be simultaneously irradiated with the same pulse of the pulse-form laser L in the irradiating process. With the irradiation of the pulse-form laser L, the three semiconductor portions 24a, 33a, and 34a and the three semiconductor portions 32a, 31a, and 24Ra are crystallized by the same degree.

According to the embodiment, three semiconductor portions 24a, 33a, and 34a and three semiconductor portions 24Ra, 31a, and 32a are crystallized by the same degree and therefore three semiconductor portions have uniform electric characteristics. With this structure, it is possible to prevent the electric characteristics of the selection transistor 24, the N-type transistor 33, and the P-type transistor 34 from having variance and it is possible to prevent the electric characteristics of the selection transistor 24R, the N-type transistor 31, and the P-type transistor 32 from having variance. That is, it is possible to manufacture the transistors 24, 33, 34, 24R, 31, and 32 having the designed electrical characteristics.

If the selection transistor 24R, the N-type transistor 31, and the P-type transistor 32 have the variance in the electrical characteristics, the current flowing across the selection transistor 24R is not sufficient for a predetermined potential of a data input terminal, and the problem with the writing to the latch circuit 25 occurs. With this embodiment, it is possible to prevent the selection transistor 24R, the N-type transistor 31, and the P-type transistor 32 from having variance in the electric characteristics, and therefore it is possible to obtain the designed electrical characteristics. In the case in which signals from the data line 50 and the reversed data line 50R are input to the latch circuit 25 by two selection transistors 24 and 24R, the writing to the latch circuit 25 can be ensured and it is possible to obtain the highly reliable electrophoretic display device 1.

### Third Embodiment

Next, a third embodiment of the invention will be described. An electrophoretic display device 201 according to this embodiment has a structure in which a transfer gate serving as a potential control switch circuit is added to the pixel 20 of FIG. 2 according to the first embodiment. Accordingly, in the drawings mentioned in the following description, elements of a pixel which are common with the pixel 20 of FIG. 2 are referenced with like references. Accordingly, detailed description of these common elements will be omitted.

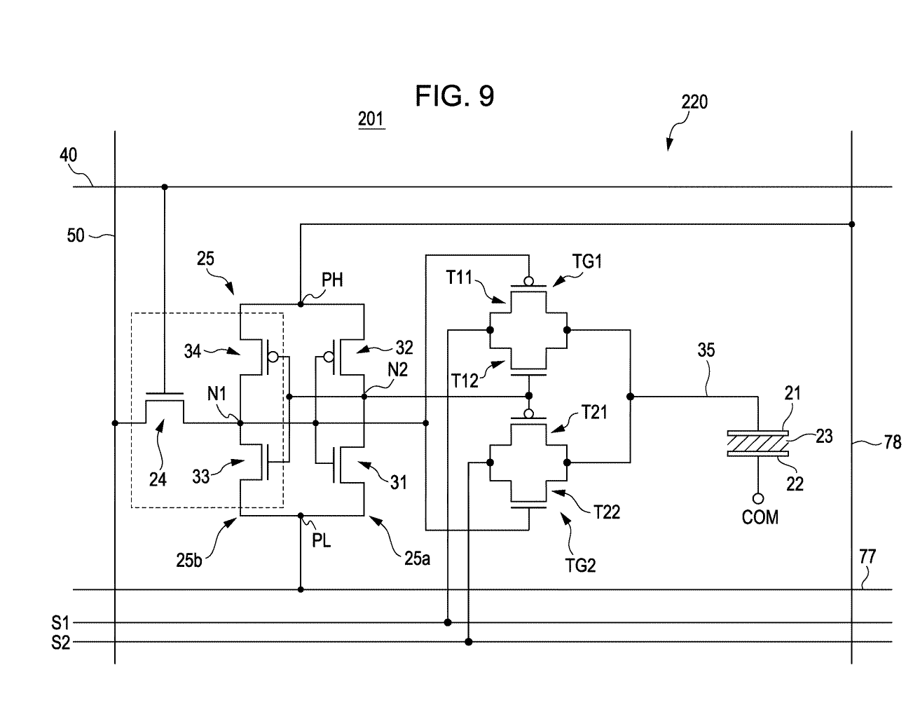

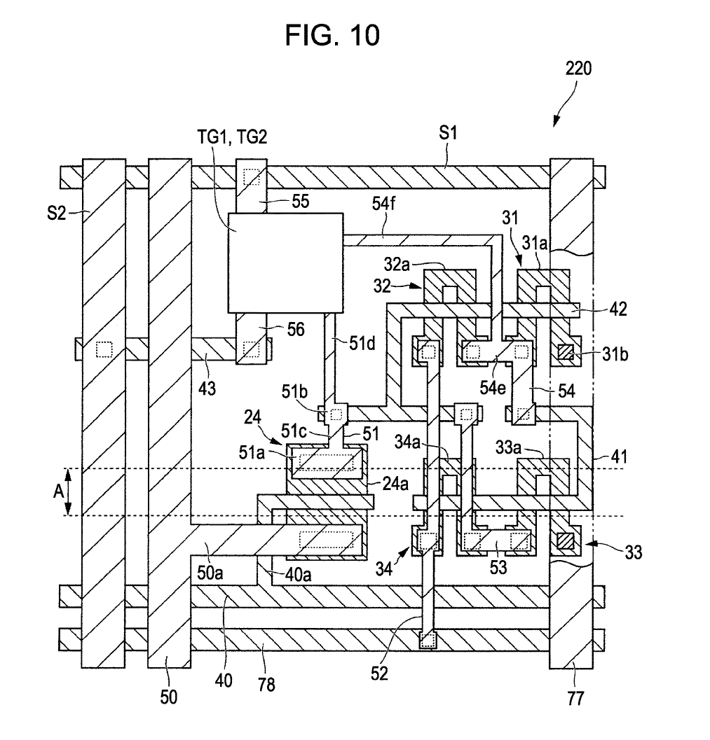

FIG. 9 shows a circuit structure of a pixel 220 of the electrophoretic display device 201, and is a view corresponding to FIG. 2 according to the first embodiment. As shown in FIG. 9, the pixel 220 includes a selection transistor 24, a latch circuit (memory circuit) 25, transmission gates TG1 and TG2 serving as a potential control switch circuit, a pixel electrode 21, a common electrode 22, and an electrophoretic element 23. A structure of the selection transistor 24 and the latch circuit 25 is the same as that of the first embodiment, and therefore description thereof will be omitted.

The transmission gate TG1 includes a field effect type P-type transistor T11 and a field effect type N-type transistor T12. A source terminal of the P-type transistor T11 is connected to a source terminal of the N-type transistor T12. Further, the P-type transistor T11 and the N-type transistor T12 are connected to a first control line S1. A drain terminal of the P-type transistor T11 is connected to a drain terminal of the N-type transistor T12. The P-type transistor T11 and the N-type transistor T12 are connected to the pixel electrode 21. A gate terminal of the P-type transistor T11 is connected to an input terminal N1 of the latch circuit 25, and a gate terminal of the N-type transistor T12 is connected to an output terminal N2 of the latch circuit 25.

The transmission gate TG2 includes a field effect type P-type transistor T21 and a field effect type N-type transistor T22. A source terminal of the P-type transistor T21 is connected to a source terminal of the N-type transistor T22. The P-type transistor T21 and the N-type transistor T22 are also connected to a second control line S2. A drain terminal of the P-type transistor T21 is connected to a drain terminal of the N-type transistor T22. The P-type transistor T21 and the N-type transistor T22 are connected to the pixel electrode 21 via a wiring 35.

A gate terminal of the P-type transistor T21 is connected to the gate terminal of the N-type transistor T12 of the transmission gate TG1 and to the output terminal N2 of the latch circuit 25. A gate terminal of the N-type transistor T22 is connected to the gate terminal of the P-type transistor T11 of the transmission gate TG1 and to the input terminal N1 of the latch circuit 25.

FIG. 10 shows an overall structure of the pixel 220 in a plan view. FIG. 10 corresponds to FIG. 5 according to the first embodiment. As shown in FIG. 10, the pixel 220 has a rectangular shape in a plan view. Like the first embodiment, the pixel 220 is surrounded by a scan line 40 formed along a lower edge of the pixel 20, a data line 50 formed along a left edge of the pixel 20, a low potential power source line 77 formed along a right edge of the pixel 20, and a high potential power source line 78 formed in parallel with the scan line 40 at the lower edge of the pixel 20. In addition to these global wirings, a first control line S1 is formed at the upper edge of the pixel 220 and a second control line S2 is formed at the left edge of the pixel 220. FIG. 10 shows the low potential power source line 77 a portion of which is cut away. In FIG. 10, a portion of the low potential power source line 77 is cut away so that an underneath portion of the low potential power source line 77 is visible.

Semiconductor portions and wiring layers are formed within the pixel 220 surrounded by the six global wirings and have a three-layered structure. A first layer, the lowermost layer, is provided with five semiconductor portions 24a, 31a, 32a, 33a, and 34a. Of the five semiconductor portions, the semiconductor portions 24a, 34a, and 33a are placed in a low in this order over a way from the left side to the right side of the figure at the lower edge side of the figure (at the scan line 40 side), and a portion of each of the semiconductor portions 24a, 34a, and 33a overlaps a predetermined area A.

With this embodiment, in addition to a structure of the pixel of the first embodiment, transmission gates TG1 and TG2 are placed at an upper left side of the pixel 220 in the figure. The transmission gates TG1 and TG2 are connected to a wiring portion 51d provided in a third layer and a wiring portion 54f, from which a portion of a wiring portion 54e branches off, provided in the third embodiment. The transmission gates TG1 and TG2 are connected to a first control line S1 via a wiring 55 provided in the third layer, and to a second control line S2 via a wiring 56 provided in the third layer and a wiring 43 provided in a second layer.

When manufacturing the electrophoretic display device 201 having the above-mentioned structure, the first layer within the pixel 220 on an element substrate is provided with semiconductor portions 24a, 31a, 32a, 33a, and 34a (semiconductor portion forming process). Then these semiconductor portions are irradiated with pulse-form laser so that these semiconductor portions are crystallized (irradiating process).

Like the first embodiment, in the semiconductor portion forming process, a semiconductor portion 24a of a selection transistor 24, and semiconductor portions 33a and 34a of an N-type transistor 33 and a P-type transistor 34 of a feedback inverter 25b are formed in a low in a predetermined area within the pixel 320 which has almost the same size as a size of an irradiation area irradiated with a single pulse of the pulse-form laser.

Since three transistors of the semiconductor portions 24a, 33a, and 34a are formed in the above-mentioned manner, the three semiconductor portions 24a, 33a, and 34a can be simultaneously irradiated with the same pulse of the pulse-form laser L in the irradiating process, so that the three semiconductor portions 24a, 33a, and 34a are crystallized by the same degree.

Returning to FIG. 9, in the pixel 220 having the above-mentioned structure, if image data with a low level from the data line 50 is input to the latch circuit 25 via the selection transistor 24, the input terminal N1 of the latch circuit 25 outputs a low level and the output terminal N2 outputs a high level. Accordingly, only the P-type transistor T11 and the N-type transistor T12 of the transmission gate TG1 are turned on. With this structure, the pixel electrode 21 is electrically connected to the first control line S1 via the wiring 35.

On the other hand, if the image data with a high level from the data line 50 is input to the latch circuit 25 via the selection transistor 24, the input terminal N1 outputs the high level and the output terminal N2 outputs the low level. Accordingly, only the P-type transistor T21 and the N-type transistor T22 of the transmission gate TG2 are turned on. With this structure, the pixel electrode 21 is electrically connected to the second control line S2 via a wiring 35.

According to this circuit structure, since potentials applied to the first control line S1 and the second control line S2 can be individually controlled by the common power source modulation circuit, whichever transmission gate is turned on, all of the pixel electrodes can be applied with the same potential.

With this structure, the display state can change among an entirely black image, an entirely white image, and a reversal image while maintaining the image data in the latch circuit 25 (regardless of maintenance data), and it is not needed to drive the driver circuit except for a period in which a new image is displayed, so that it is possible to more smoothly perform a display.

According to this embodiment, three semiconductor portions 24a, 33a, and 34a are crystallized by the same degree and therefore the electrical characteristics of the three semiconductor portions 24a, 33a, and 34a are almost uniform. With this structure, it is possible to prevent the selection transistor 24, the N-type transistor 33, and the P-type transistor 34 from having variance in the electrical characteristics, and therefore it is possible to prevent malfunction of the latch circuit 25 even in the case in which the transmission gates TG1 an TG2 are provided.

### Fourth Embodiment

Next, a fourth embodiment of the invention will be described. An electrophoretic display device 301 according to this embodiment has a structure in which a reversed data line and a selection transistor connected to the reversed data line are added to the pixel 220 shown in FIG. 9 according to the third embodiment. Accordingly, in the drawings mentioned in the following description, common elements of a pixel which are common with elements of the pixel 220 of FIG. 9 will be referenced with like references and description thereof will be omitted.

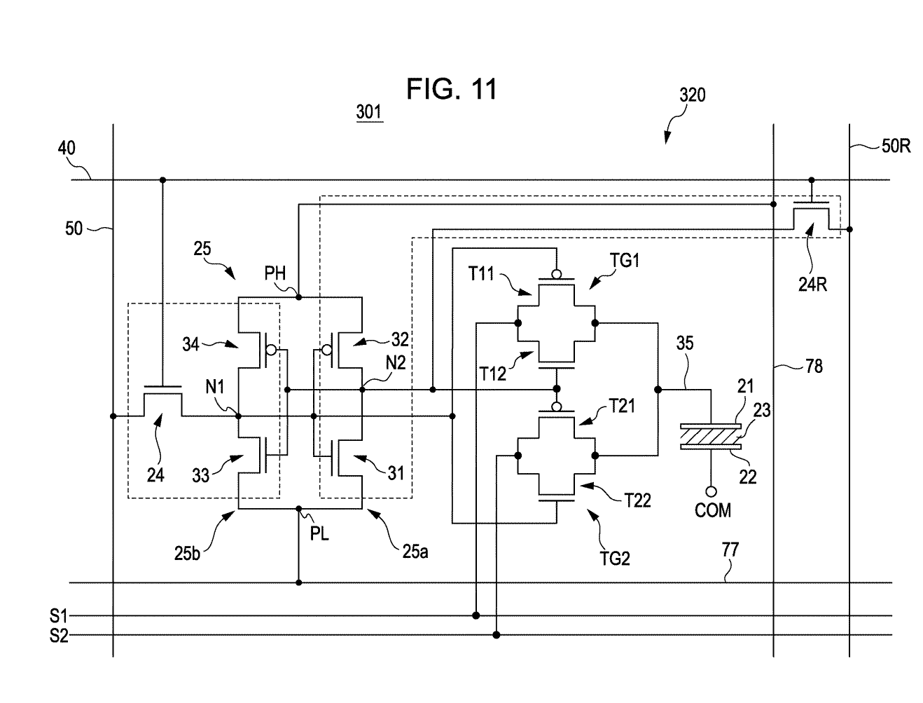

FIG. 11 shows a circuit structure of a pixel 320 of the electrophoretic display device 301, and corresponds to FIG. 9 according to the third embodiment. As shown in FIG. 11, the pixel 320 includes a selection transistor 24, a selection transistor 24R, a latch circuit (memory circuit) 25, transmission gates TG1 and TG2 serving as a potential control switch circuit, a pixel electrode 21, a common electrode 22, and an electrophoretic element 23. A structure of the selection transistor 24 and the latch circuit 25 according to this embodiment is the same as that of the first embodiment. A structure of the selection transistor 24R is the same as that of the second embodiment. A structure of the transmission gates TG1 and TG2 is the same as that of the third embodiment.

In this embodiment, a scan line 40 and a data line 50 which are connected to the selection transistor 24, a reversed data line 50R connected to the selection transistor 24R, a low potential power source line 77 and a high potential power source line 78 which are connected to the latch circuit 25, and a first control line S1 and a second control line S2 connected to the transmission gates TG1 and TG2, respectively are wired to a single pixel 320.

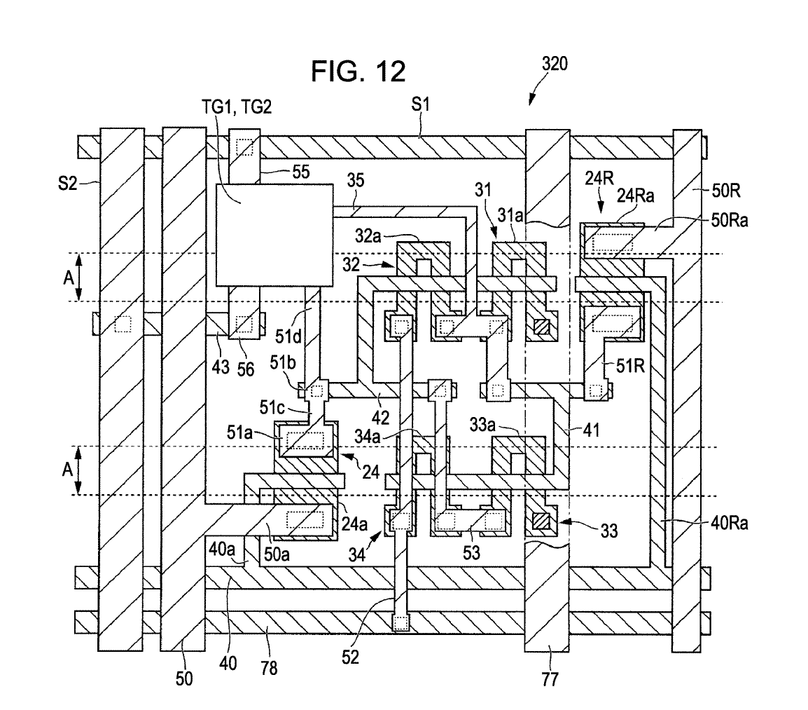

FIG. 12 shows an overall structure of the pixel 320 in a plan view, and is a view corresponding to FIG. 5 according to the first embodiment. As shown in FIG. 12, the pixel 320 has a rectangular shape in a plan view. Like the first embodiment, the pixel 320 is surrounded by the scan line 40 formed along a lower edge of the pixel 320, the data line 50 formed along a left edge of the pixel 320, the low potential power source line 77 formed along a right edge of the pixel 320, and the high potential power source line 78 which is in parallel with the scan line 40 and formed at the lower edge of the pixel 320. In addition to these global wirings, a space is provided between the right edge of the pixel 320 and the low potential power source line 77, and the reversed data line 50R is formed in the space. The first control line S1 is formed at the upper edge of the pixel 320, and the second control line S2 is formed at the left edge of the pixel 320. FIG. 12 shows the low potential power source line 77 a portion of which is cut away so that an underneath portion of the low potential power source line 77 is visible.

Semiconductor portions and wiring layers are formed in the pixel 320 surrounded by the seven global wirings and have a three-layered structure. A first layer, the lowest layer, is provided with semiconductor portions 24a, 31a, 32a, 33a, 34a, and 24Ra. That is, the total six semiconductor portions are provided in the first layer.

Of the six semiconductor portions, the semiconductor portions 24a, 34a, and 33a are placed in a row in this order over a way from the left side to the right side of the figure at the lower edge side of the pixel (at the scan line 40 side), and a portion of each of the semiconductor portions 24a, 34a, and 33a overlaps a predetermined area A. Of the six semiconductor portions, the semiconductor portions 32a, 31a, and 24Ra are placed in a row in this order over a way from the left side to the right side of the figure at the upper edge of the pixel 320 within the pixel 320 and a portion of each of the semiconductor portions 32a, 31a, and 24Ra overlaps the predetermined area A.

In this embodiment, the transmission gates TG1 and TG2 are placed at an upper right portion within the pixel 320. A contact structure between each of the transmission gates TG1 and TG2 and each of the wirings is the same as that of the third embodiment, and therefore description thereof will be omitted.

When manufacturing the electrophoretic display device 301 having the above-mentioned structure, the first layer within the pixel 320 on an element substrate is provided the semiconductor portions 24a, 31a, 32a, 33a, 34a, and 24Ra (semiconductor portion forming process). These semiconductor portions are irradiated with the pulse-form laser and therefore the semiconductor portions are crystallized (irradiating process).

In this embodiment, it is possible to manufacture the structure of the second embodiment by irradiating the six semiconductor portions with light, a group of the three semiconductor portions 24a, 33a, and 34a is crystallized by the same degree and a group of the three semiconductor portions 32a, 31a, and 24Ra is crystallized by the same degree.

According to this embodiment, the group of the semiconductor portions 24a, 33a, and 34a is crystallized by the same degree, and the group of the semiconductor portions 24Ra, 31a, and 32a is crystallized by the same degree. The electrical characteristics of the three semiconductor groups in each of the groups become uniform. In this manner, it is possible to prevent the selection transistor 24, the N-type transistor 33, and the P-type transistor 34 from having variance in the electrical characteristics and it is also possible to prevent the selection transistor 24R, the N-type transistor 31, and the P-type transistor 32 from having variance in the electrical characteristics. With this structure, in the case in which the transmission gates TG1 and TG2 are provided and the signals from the data line 50 and the reversed data line 50R are input to the latch circuit 25 by two selection transistors 24 and 24R, it is possible to prevent malfunction of the latch circuit 25 from occurring.

The technical scope of the invention is not limited to the above embodiments and the embodiments may be properly modified and altered within a range not departing from the effect of the invention. In the electrophoretic display devices according to the third and fourth embodiments, since each of the transmission gates TG1 and TG2 is composed of two transistors. However, the invention is not limited to the structures of the embodiments. That is, each of the transmission gates TG1 and TG2 may be composed of a single transistor.

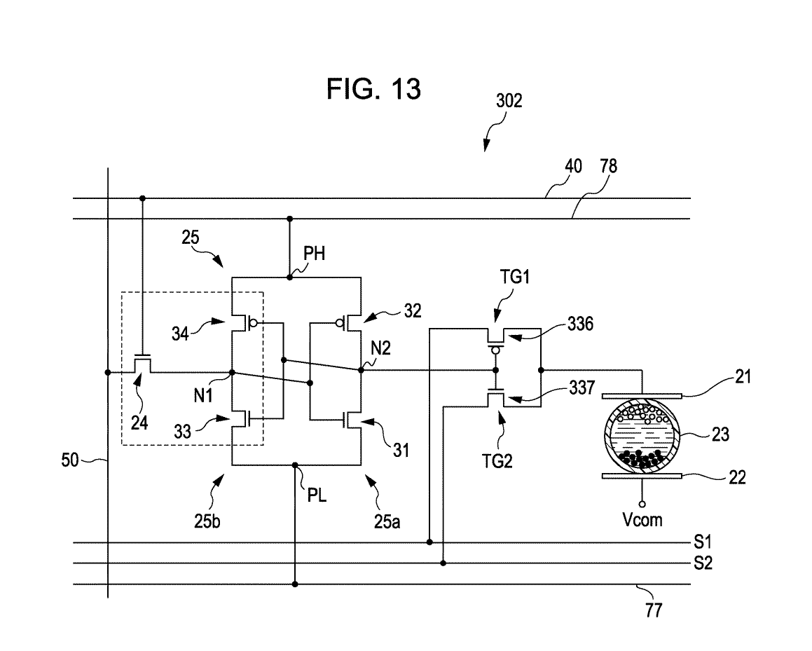

For example, as shown in FIG. 13, one of the transmission gate TG1 may be a switch circuit formed by a P-type transistor and the other transmission gate TG2 may be a switch circuit formed by an N-type transistor. The transmission gates TG1 and TG2 are connected between the output terminal N2 of the latch circuit 25 and the pixel electrode 21. Gate terminals of the P-type transistor 336 and the N-type transistor 337 are connected to each other and are connected to the output terminal N2 of the latch circuit 25.

A source terminal of the P-type transistor 336 is connected to the first control line S1 and a drain terminal of the P-type transistor 336 is connected to the pixel electrode 21. A source terminal of the N-type transistor 337 is connected to the second control line S2, and a drain terminal of the P-type transistor 337 is connected to the pixel electrode 21.

In the pixel 302 having the above-described structure, when a high level is input as an image signal, a low level potential is output from the output terminal N2 of the latch circuit 25. Accordingly, the P-type transistor 336 is turned and therefore the first control line S1 and the pixel electrode 21 are connected to each other.

On the other hand, when a low level is input to the pixel 302 as the image signal, a high level potential is output from the output terminal N2 of the latch circuit 25. Accordingly, the N-type transistor 337 is turned on and therefore the second control line S2 and the pixel electrode 21 are connected to each other.

The transmission gates TG1 and TG2 of the pixel 302 are driven by the potential of the image signal input to the latch circuit 25 and the first control line S1 and the second control line S2 are connected to the pixel electrode 21. With such a structure, the pixel electrode 21 is provided with a potential of the first control line S1 or a potential of the second control S2.

In a plan view of a structure of the pixel 302 shown in FIG. 12, only the transmission gates TG1 and TG2 are different but other members shown in FIG. 12 other than the transmission gates TG1 and TG2 are the same. For such a reason, in the electrophoretic display device equipped with the transmission gate composed of two transistors, the semiconductor portions are formed by the same processes of each of the embodiments, and the semiconductor portions can be irradiated with the laser so that all of the semiconductor portions are crystallized by the same degree.

The entire disclosure of Japanese Patent Application No. 2008-047570, filed Feb. 28, 2008 is expressly incorporated by reference herein.

What is claimed is:

1. A manufacturing method of an electrophoretic display device,
the electrophoretic display device comprising:
a pair of substrates;
an electrophoretic element interposed between the pair of substrates, the electrophoretic element containing electrophoretic particles; and
a display portion with a plurality of pixels, each pixel including a selection transistor and a latch circuit connected to the selection transistor, and
the manufacturing method comprising:
a semiconductor portion forming process for forming a first semiconductor portion which constitutes the selection transistor and a second semiconductor portion composed of a plurality of transistors which constitutes a feedback inverter of the latch circuit so that the first semiconductor portion and the second semiconductor portion are placed in a straight line form extending in a direction of arrangement of the pixels; and
an irradiating process for irradiating the first and second semiconductor portions with pulse-form light along the arrangement of the straight line form.

2. The manufacturing method of an electrophoretic display device according to claim 1, wherein in the semiconductor portion forming process, a plane area serving as a channel region of the selection transistor of the first semiconductor portion and a plane area serving as channel regions of the plurality of selection transistors of the second semiconductor portion are placed in a straight line form in the arrangement direction of the pixels.

3. The manufacturing method of an electrophoretic display device according to claim 1, wherein in the semiconductor portion forming process, the first and second semiconductor portions are formed at an area, which is irradiated with the pulse-form light in the irradiating process.

4. The manufacturing method of an electrophoretic display device according to claim 1, wherein in the semiconductor portion forming process, the first semiconductor portions and the second semiconductor portions of the plurality of pixels are placed in a straight line form in the direction of arrangement of the pixels.

5. The manufacturing method of an electrophoretic display device according to claim 1, wherein the plurality of pixels is a plurality of pixels belonging to one scan line or one data line of scan lines or data lines which extend in the display portion.

6. An electrophoretic display device, comprising:
a pair of substrates;
an electrophoretic element interposed between the pair of substrates, the electrophoretic element containing electrophoretic particles; and
a display portion with a plurality of pixels,
wherein each pixel includes a selection transistor and a latch circuit connected to the selection transistor, and
wherein a first semiconductor portion which constitutes the selection transistor and a second semiconductor portion of a plurality of transistors which constitutes a feedback inverter of the latch circuit are arranged in a straight line form extending in a direction of arrangement of the pixels.

7. The electrophoretic display device according to claim 6, wherein the first and second semiconductor portions of the plurality of pixels are placed in a straight line form extending in the direction of arrangement of the pixels.

8. The electrophoretic display device according to claim 6, wherein the plurality of pixels is a plurality of pixels belonging to one scan line or one data line of scan lines or data lines which extend in the display portion.

9. An electronic apparatus comprising the electrophoretic display device according to claim 6.
